(19) United States
(12) Patent Application Publication
(10) Pub. No.: US 2026/0044790 A1
(43) Pub. Date: Feb. 12, 2026

(54) SYSTEMS AND METHODS FOR SPACE ALLOCATION AND SCHEDULING

(71) Applicant: FMR LLC, Boston, MA (US)

(72) Inventors: Robert William Vick, Plymouth, MA (US); Alexander Gorski, Cumberland, RI (US); Charlene Adele Gilmore, Cary, NC (US); Edyta Zmiejko, Marlborough, MA (US); Ved Shelat, Delaware, OH (US); Dana Schalk, Nashua, NH (US); Venkateshwar Reddy Pagidi, Nashua, NH (US); Anuj Manuja, Lexington, MA (US)

(21) Appl. No.: 18/796,961

(22) Filed: Aug. 7, 2024

(51) Int. Cl. G06Q 10/04; G06Q 10/0631

(52) U.S. Cl. CPC G06Q 10/04; G06Q 10/06311

(57) ABSTRACT

A computer-implemented method is provided for scheduling employees' attendance to an office and allocating office space to accommodate the employees. The method includes assigning each of the employees to a plurality of employee teams based on enterprise information received. The method also includes allowing a user to adjust multiple optimization controls including one or more team group controls, scheduling controls and space controls. Each of the optimization controls represents at least one of a constraint that must be satisfied or a constraint satisfaction of which is optional. The method further including executing an optimization algorithm to simultaneously schedule the employee teams' attendance to the office over one or more periods of time while allocating a plurality of office space zones to the employee teams during the one or more periods of time. The optimization algorithm receives as inputs information about the employee teams, office space data and the optimization controls.

### BACKGROUND

### Technical Field

This application generally relates to systems, methods and apparatuses, including computer program products, for scheduling employee attendance to an office and allocating office space to accommodate the employees during attendance.

### Background Information

Current market offerings of office space allocation tools focus on fixed space allocations without taking into consideration dynamic scheduling variables including dynamic timeframe requirements or variable organizational structure. Therefore, there is a need for office space allocation tools that can offer dynamic stack planning, account for business needs, and accept configurable inputs to generate enterprise team groupings, schedule assignments for these team groupings, and allocate space assignments for the scheduled team groupings based on user desired time horizons.

### SUMMARY

The present invention features an optimizer configured to provide a streamlined path to dynamically define space allocations based on the enterprise's organizational structure and associated organizational nuances. The optimizer allows a user to match the demand of space by an employee population coming into the office with the available supply while accounting for multiple business variables including organizational structure, agile teams, business adjacencies, etc. More specifically, this optimizer can identify who to bring into the office, when, and in what groupings, such that space occupancy and employee experience are optimized. In some embodiments, the optimizer is configured to optimally fill space over a set timeframe (daily, weekly, monthly, etc.) and optimize the total occupancy footprint. The optimizer can also be configured to prioritize organizational groupings and adjacencies to optimize employee experience. For a business organization, the optimizer of the present invention ensures that the organization meets the demands for seats and allows the organization to maximize the use of available spaces by dynamically matching the space demand with available supply within a defined timeframe. This tool can also ensure that employees can be scheduled to attend the office the same time as other teams they interact with the most due to business adjacencies.

In one aspect, the present invention features a computer-implemented method for scheduling a plurality of employees' attendance to an office and allocating office space to accommodate the plurality of employees. The method comprises receiving, by a computing device, enterprise information related to the plurality of employees including company organizational data defining a hierarchy of the employees and assigning, by the computing device, each of the plurality of employees to a plurality of employee teams based on the enterprise information received. Each employee team is associated with a team size and a duration the employee team needs to be in the office. The method also includes receiving, by the computing device, office space data comprising a plurality of zones demarcating spaces within the office. Each zone is associated with one or more seats and a set of location coordinates. The method additionally includes adjusting by a user, via the computing device, a plurality of optimization controls comprising (i) one or more team group controls setting conditions on which of the employee teams should come into the office, (ii) one or more scheduling controls setting conditions on when the employee teams should come into the office, and (iii) one or more space controls setting conditions on which of the zones to allocate to the employee teams. Each of the optimization controls represents at least one of a constraint with conditions that must be satisfied or a preference with conditions satisfaction of which are optional. The method further includes executing, by the computing device, an optimization algorithm to simultaneously schedule the employee teams attendance to the office over one or more periods of time while allocating the plurality of zones to the employee teams during the one or more periods of time. The optimization algorithm receives as inputs the plurality of employee teams, the office space data and the plurality of optimization controls.

In another aspect, the present invention features a computer-implemented system for scheduling a plurality of employees' attendance to an office and allocating office space to accommodate the plurality of employees. The computer-implemented system comprises a computing device having a memory for storing instructions. The instructions, when executed, configure the computer-implemented system to provide an input module, a team assignment module, an optimization control adjustment module and an optimization module. The input module is configured to receive (i) enterprise information comprising company organizational data defining a hierarchy of the plurality of employees, and (ii) office space data comprising a plurality of zones demarcating spaces within the office each zone being associated with one or more seats and a set of location coordinates. The team assignment module configured to assign each of the plurality of employees to a plurality of employee teams based on the enterprise information, wherein each employee team is associated with a team size and a duration the employee team needs to be in the office. The optimization control adjustment module is configured to allow a user to adjust a plurality of optimization controls comprising (i) one or more team group controls setting conditions on which of the employee teams should come into the office, (ii) one or more scheduling controls setting conditions on when the employee teams should come into the office, and (iii) one or more space controls setting conditions on which of the zones to allocated to the employee teams. Each of the optimization controls represents at least one of a constraint with conditions that must be satisfied or a preference with conditions satisfaction of which are optional. The optimization module is configured to execute an optimization algorithm to simultaneously schedule the employee teams to come into the office over one or more periods of time while allocating the plurality of zones to the employee teams during the one or more periods of time. The optimization algorithm receives as inputs the plurality of employee teams, the office space data and the plurality of optimization controls.

Any of the above aspects can include one or more of the following features. In some embodiments, each of the one or more seats in each zone is classified into one of a plurality of seat types including a common space, a restricted space, a dynamic space, a phone space, and a support space. In some embodiments, the office space data further includes at least one of a space matrix providing a view of space capacity available for allocation via the optimization algorithm and space-designated data correlating the plurality of employee teams to their corresponding requirements on the seat types.

In some embodiments, the optimization algorithm is adapted to fail if an optimization control that represents a constraint cannot be satisfied, and the optimization algorithm is adapted to generate at least one scheduling and allocation assignment if an optimization control that represents a preference is not satisfied. In some embodiments, the optimization algorithm is a mixed-integer linear programming algorithm.

In some embodiments, each optimization control corresponds to a strength value indicating a degree of preference for the respective optimization control, and wherein a blank strength value indicates that the corresponding optimization control is a constraint the satisfaction of which is required.

In some embodiments, executing the optimization algorithm comprises executing a first phase for scheduling the teams attendance to the office over one or more periods. In some embodiments, a wiggle room control of the first phase of optimization specifies a certain amount of space in the office to be left vacant and not available for allocation by the optimization algorithm. In some embodiments, a minimize vacancy control of the first phase of optimization specifies minimization of vacant zones in the office. The corresponding strength value sets a degree of penalization against vacancy. In some embodiments, a maximize fill control of the first phase of optimization specifies a consistent number of occupied spaces that need to be maintained over multiple periods of time. The corresponding strength value specifies an importance level of the maximize fill control.

In some embodiments, a minimize out-of-office control of the first phase of optimization specifies in-office requirements of the employee teams by limiting a number of consecutive periods of time the employee teams are allowed to be out of the office, and the corresponding strength value sets a degree of penalization against dispersion. In some embodiments, a co-presence control of the first phase of optimization specifies an employee team being in office at the same time as one or more other employee teams across the organizational hierarchy. In some embodiments, a period control of the first phase of optimization specifies one or more employee teams that need to be to be in the office during a predefined period of time.

In some embodiments, executing the optimization algorithm further comprises executing a second phase at least once per scheduled period determined from the first phase for allocating the plurality of zones to the scheduled teams determined from the first phase. In some embodiments, a dispersion penalty control of the second phase encourages a list of one or more user-specified employee teams to be located near each other. The corresponding strength value sets a degree of penalty for dispersion of the user-specified employee teams. In some embodiments, a shufflage penalty control of the second phase discourages moving a list of one or more user-specified employee teams to a different zone during a user-specified time period in comparison to a previous time period. The corresponding strength value sets a degree of penalty for shuffling the user-specified employee teams to the different zone. In some embodiments, a co-location control of the second phase specifies one or more employee teams to be located near each other. In some embodiments, a location preference control of the second phase specifies a zone of the office to place one or more user-specified employee teams. In some embodiments, an exclusivity control of the second phase reserves a zone of the office for exclusive use by a list of one or more user-specified employee teams.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary diagram of a space and scheduling optimization system, according to some embodiments of the present invention.

FIG. 2 shows an exemplary process utilized by the space and scheduling optimization system of FIG. 1 to group, schedule and allocate space to employees, according to some embodiments of the present invention.

FIG. 3 shows an exemplary graphical user interface (GUI) produced by the space and scheduling optimization system of FIG. 1 to display optimization results to a user, according to some embodiments of the present invention.

FIG. 4 shows another exemplary GUI produced by the space and scheduling optimization system of FIG. 1 to present filtered associate assignment details after the user sets one or more filter options from the GUI of FIG. 3, according to some embodiments of the present invention.

FIG. 5 shows yet another exemplary GUI produced by the space and scheduling optimization system of FIG. 1 to present to an associate his/her schedule and space assignments and related details, according to some embodiments of the present invention.

FIG. 6 shows an exemplary GUI adapted for mobile devices, according to some embodiments of the present invention.

### DETAILED DESCRIPTION

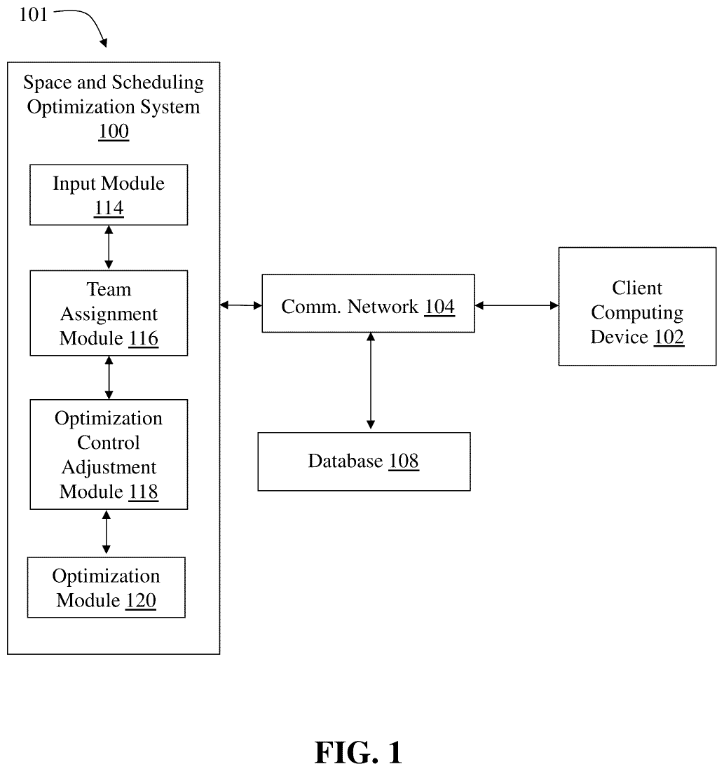

FIG. 1 shows an exemplary diagram of space and scheduling optimization system 100 used in a computing environment 101 for automatically grouping, scheduling and allocating space to employees of an organization, according to some embodiments of the present invention. As shown, computing environment 101 generally includes at least one client computing device 102, a communication network 104, the space and scheduling optimization system 100, and at least one database 108.

The client computing device 102 can be associated with a user who would like to define space allocation and scheduling for multiple employees across an organization. The client computing device 102 can connect to the communication network 104 to interact with the space and scheduling optimization system 100 and/or the database 108 to provide inputs and receive outputs for display to the user. Exemplary computing devices 102 include, but are not limited to, telephones, desktop computers, laptop computers, tablets, mobile devices, smartphones, and internet appliances. It should be appreciated that other types of computing devices capable of connecting to the components of the computing environment 101 can be used without departing from the scope of invention. Although FIG. 1 depicts a single computing device 102, it should be appreciated that the computing environment 101 can include any number of client devices for communication by any number of users.

The communication network 104 enables components of the computing environment 101 to communicate with each other to perform the task of space optimization and scheduling. The network 104 may be a local network, such as a LAN, or a wide area network, such as the Internet and/or a cellular network. In some embodiments, the network 104 is comprised of several discrete networks and/or sub-networks (e.g., cellular to Internet) that enable the components of the system 100 to communicate with each other.

The space and scheduling optimization system 100 is a combination of hardware, including one or more processors and one or more physical memory modules and specialized software engines that execute on the processor of the image generation system 100, to receive data from other components of the computing environment 101, transmit data to other components of the computing environment 101, and perform functions as described herein. As shown, the space and scheduling optimization system 100 executes an input module 114, a team assignment module 116, an optimization control adjustment module 118, and an optimization module 120. These sub-components and their functionalities are described below in detail. In some embodiments, the various components of the space and scheduling optimization system 100 are specialized sets of computer software instructions programmed onto a dedicated processor in the system 100 and can include specifically designated memory locations and/or registers for executing the specialized computer software instructions.

The database 108 is a computing device (or in some embodiments, a set of computing devices) that is coupled to and in communication with the space and scheduling optimization system 100 and is configured to provide, receive and store various types of data received and/or created for space allocation and scheduling purposes. In some embodiments, all or a portion of the database 108 is integrated with the system 100 or located on a separate computing device or devices. For example, the database 108 can comprise one or more databases, such as MySQL™ available from Oracle Corp. of Redwood City, California.

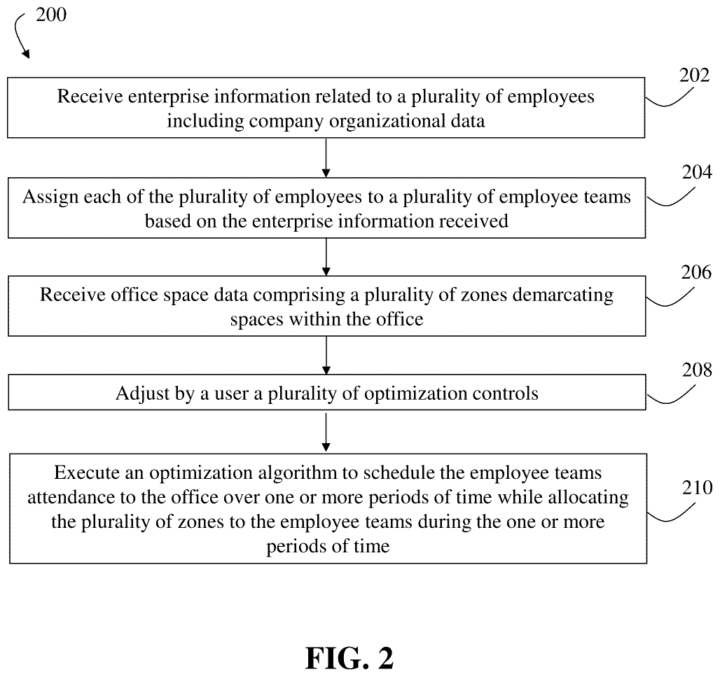

FIG. 2 shows an exemplary process 200 utilized by the space and scheduling optimization system 100 of FIG. 1 to group, schedule and allocate space to employees, according to some embodiments of the present invention. In general, the optimization process 200 identifies how office space can be occupied optimally while bringing employees into the office in a meaningful manner. Process 200 accomplishes this goal by taking into consideration one or more of employee groupings, schedule assignments and space assignments. In relation to employee groupings, the optimization system 100 is configured to group employees into teams that can be scheduled to come to the office together and sit within the same zone. Team groupings can be prioritized at the business unit, cost center, agile/non-agile, etc. levels as determined from enterprise human resource systems. In relation to schedule assignments, the optimization system 100 is configured to allocate each of the employee teams to a business-defined timeframe (daily, weekly, monthly, etc.). During this timeframe, the team is also allocated a seat. When assigning schedules, the optimization system 100 can group like teams together, which can be prioritized over optimally occupying space. Alternatively, space occupancy can be prioritized over team alignment. A mixed priority can also be set, dependent on user adjustment of certain optimization controls. In relation to space assignments, the optimization system 100 is configured to allocate seating (e.g., user-configurable percentage of seats) to employee teams for use during the team's scheduled assignment. In addition, team adjacencies and other space-related constraints/preferences can be prioritized. Furthermore, to support the dynamic nature of a business, the space and scheduling optimization system 100 can periodically update assignments that accounts for new-hires, job changes, organizational changes, etc.

To implement team groupings, the input module 114 of the space and scheduling optimization system 100 is configured to receive, at step 202, enterprise information (e.g., enterprise metadata) related to multiple employees of an organization, including organizational data defining a company hierarchy of the employees and Agile data. Organizational data can be derived from business groups, business units, finance details, cost centers, etc. Agile data can be derived from the company's internal Agile organization platform. At step 204, the team assignment module 116 of the space and scheduling optimization system 100 is configured to assign each of the employees to an employee team based on the enterprise information received, including the organizational data and the Agile data In some embodiments, teams generated from the Agile data do not align with the organizational structure from the organizational data, in which case the team assignment module 116 is configured to reconcile the structures from the two different sources to generate a single set of team groupings for the employees.

Each employee team represents a collection of employees that share a common business function and for which the optimization system 100 needs to place. Each employee team can have a team definition including a name, a size (e.g., the number of employees assigned to the team), and a duration limitation that the employee team needs to be in the office (e.g., the minimum and maximum number of periods the team must be in office). In some embodiments, a periodic setting can be included in each team definition, indicating the frequency the team needs to be in the office. For example, a value of 4 for the periodic setting indicates that the team needs to be in the office every 4 periods. This setting can override the duration limitation setting (e.g., the minimum and maximum in-office periods). If there are seat-type requirements for a team, these requirements are also included in the team definition. In some embodiments, the team size is at least the sum of seat types defined. If the team size is larger, the optimization system 100 can put the excess employees into any type of seat.

In some embodiments, teams can be assigned to different tiers (hereinafter referred to as “team tiers”). For example, a team can be designated as belonging to a squad of a tribe of a community. In some embodiments, team names include their tier designation separated by a “|” (e.g., “CommX|TribeY|SquadZ” or “CommX|TribeY” or “CommX”). In some embodiments, teams can be assigned to different groups (hereinafter referred to as “team groups”), where a group does not form a tier. Therefore, each team group includes a collection of teams without any hierarchical tier formation. In some embodiments, a team group is defined by a list of team names and/or team tier names.

To schedule and allocate space to the teams (or team groups/team tiers), the input module 114 of the optimization system 100 is also configured to receive, at step 206, office space data (e.g., regional campuses, buildings, floors, and count of workspaces), where the office spaces are demarcated and identified as zones within an office. More specifically, each unit of office space is called a “zone”. Each zone can house all or parts of any number of teams. For example, on any given physical floor, there can be several zones, classified in alphabetical order (Zone A, Zone B, etc.). In some embodiments, each zone is defined by a name, zone capacity that includes the aggregated number of seats within the zone and their associated “seat types” (e.g., a zone may have a capacity of 18 seats, with 10 dynamic seats and 8 phones seats), and location coordinates of the zone. Available seat types include, but are limited to, common (reservable space that is currently unassigned), restricted (special badge access required apace that is assignable via optimization), dynamic (fungible space that is assignable via optimization), phone (space with a desk phone that is assignable via optimization), and support (non-standard space allocated to facilities staff that is assignable via optimization). In some embodiments, the location coordinates of a zone define zone adjacency information to support large community assignments across neighboring zones. Coordinate data is associated with each zone and reflects zone, floor, building and property level adjacency details.

Optionally, the office space data received by the input module 114 can also include a space matrix, which represents a view of space capacity available for allocation through the optimization process 200. This matrix can include seat counts by zones, further broken down by seat types. Optionally, the office space data can further include space designated data, such as visualization of a map associating business units, business groups, etc. to corresponding cost centers to create space designations. In some embodiments, the business units requiring non-standard seating spaces can be correlated to designated spaces via this space designated view/map. In some embodiments, such a mapping of business units to cost centers can be used with the space matrix view to articulate which parts of the business require which seat types. Thus, the space matrix view provides available capacity details for a given property, building, floor, zone, and cost center. Furthermore, these views enable space designations for defined business units. For example, Business Unit A may be aligned to a Seat Type of Phones. Due to this designation, the optimization system 100 is configured to only allocate to Business Unit A zones with an appropriate count of phones seats.

In some embodiments, zones can be assigned to different tiers (hereinafter referred to as “zone tiers”). For example, a zone can be designated as an area within a floor of a building. There is no specific limit on the number of tiers. In some embodiments, zone names include their tier locations separated by a “|” (e.g., “Bldg245|Floor12|PO”). In some embodiments, zones can be assigned to different groups (hereinafter referred to as “zone groups”), where a group does not form a tier. Therefore, each zone group includes a collection of zones without any hierarchical tier formation. In some embodiments, a zone group is defined by a list of zone names and/or zone tier names. In some embodiments, the input module 114 can determine the distance between any pair of the office zones. For example, the input module 114 can calculate the distance between two zones as the sum of the absolute differences of the coordinates defining the respective zones.

To schedule and allocate space to the teams (or team groups/team tiers), the input module 114 of the optimization system 100 is further configured to receive duration for placing a team. In some embodiments, the duration is defined in units of period, where each period designates a consecutive block of time (e.g., days, weeks, months, etc.).

Optionally, the input module 114 of the optimization system 100 can receive as an optional input prior assignments for one or more of the teams, if available. Such prior assignments can be used by the optimization system 100 to formulate current assignments, which will be explained below in detail. An exemplary format of the prior assignments as an input to the optimization system 100 can be:

| comm | tribe | squad | period | fl | sect | size | cube | office |
|---|---|---|---|---|---|---|---|---|
| c1 | c1\|t11 | c1\|t11\|s111 | p2 | fl1 | fl1\|sect1 | 15.0 | 11.0 | 4.0 |
| c1 | c1\|t11 | c1\|t11\|s112 | p2 | fl1 | fl1\|sect3 | 6.0 | 2.0 | 4.0 |
| c1 | c1\|t11 | c1\|t11\|s113 | p2 | fl1 | fl1\|sect3 | 6.0 | 6.0 | 0.0 |
| c1 | c1\|t11 | c1\|t11\|s114 | p1 | fl1 | fl1\|sect2 | 6.0 | 2.0 | 4.0 |
| c1 | c1\|t11 | c1\|t11\|s115 | p2 | fl1 | fl1\|sect3 | 6.0 | 6.0 | 0.0 |
| . . . | . . . | . . . | . . . | . . . | . . . | . . . | . . . | . . .\| |

As shown, the first three columns indicate the team names with tier designations, the “period” column specifies time (in terms of period) assignments to the corresponding teams, the next two columns indicate zone assignments to the corresponding teams, the cube and office columns are reference values indicating the count of enclosed offices and open floor workstations, respectively, available within the corresponding zones, and the “size” column indicates the total count of “offices” and “cubes” in the corresponding zones.

At step 208 of process 200, the optimization control adjustment module 118 allows the user to set/adjust one or more optimization controls for specifying different requirements and/or preferences for space allocation to and scheduling of the teams. These optimization controls are parameters that enable planning ratios, vacancy within the site, building, floor, etc. The optimization controls can be broadly placed into three categories including (i) one or more team group controls setting conditions on which of the employee teams should come into the office, (ii) one or more scheduling controls setting conditions on when the employee teams should come into the office, and (iii) one or more space controls setting conditions on which of the zones to allocate to the employee teams. In addition, each of the optimization controls represents at least one of a constraint with conditions that must be satisfied or a preference with conditions satisfaction of which are optional. Certain optimization controls can be either a constraint or a preference depending on their configuration; these dynamic controls are classified as “hybrid” optimization controls.

Each optimization control is associated with multiple user-adjustable settings to increase or decrease its priority within the optimization algorithm. For example, an optimization control can be adjusted to increase the count of available vacant spaces within any given optimization at the floor or building level. One setting of an optimization control is a coefficient setting specifying a degree of preference. A larger value indicates a larger preference. A blank value indicates that the corresponding control is a constraint (i.e., satisfaction of which is required). In some embodiments, these values are relative to each other and have no absolute meaning. For example, optimization control a is treated as more important than optimization control b if optimization control a has a higher coefficient setting than that of optimization control b. In some embodiments, those optimization controls that indicate preferences are “additive.” For example, if a team is in multiple different scopes for a single optimization control, the preference for that team is the sum of those coefficients. Another user-adjustable setting of an optimization control is the org setting which indicates the organizational unit the optimization control applies to, with a blank value indicating that it applies to each team; otherwise, this setting can be a team name, a team tier, or a team group name. Yet another user-adjustable setting of an optimization control is the space setting which indicates the unit of space the optimization control applies to, with a blank value indicating that it applies to the entire set of office zones; otherwise, this setting can be a zone tier name, which may be a building or a floor, for example. In general, each optimization control does not need to have all of the affiliated settings set to specific values; a blank setting can indicate that the corresponding optimization control applies to all teams and/or zones.

At step 210, the optimization module 120 executes an optimization algorithm to schedule the employee teams' attendance to the office over one or more periods of time and allocate one or more of the office zones to the employee teams during the scheduled periods of time, while considering a number of user-selected optimization goals. The optimization algorithm accomplishes the allocation and scheduling based on the inputs received, including the employee teams assigned at step 204, the office space data received at step 206 and the optimization controls with user-adjusted settings at step 208. The optimization algorithm is configured to be generally indifferent to what these inputs represent, for example, whether periods are days, weeks or months, or teams are squads or community groups or some other combinations. The optimization algorithm can be formulated as a mixed-integer linear programming problem using Gurobi, for example. In some embodiments, the optimization algorithm includes n+1 separate optimizations, where n is the number of periods to optimize, and each optimization is a minimization problem. In some embodiments, the optimization algorithm fails and returns without an output if an optimization control that represents a constraint cannot be satisfied. However, the optimization algorithm still can return an output if an optimization control that represents a preference cannot be satisfied. The optimization algorithm is configured to attempt to satisfy as many preferences as possible. In some embodiments, the optimization algorithm can leverage prior assignment details from previous optimizations runs, where the prior assignments enable the possibility of creating consistency in assignments from one period to the next. In some embodiments, the optimization algorithm is implemented in two phases, with the first phase configured to determine which time periods each team will be in office and the second phase configured to determine team locations within the office for each scheduled time period.

More specifically, the first phase of optimization at step 210 involves choosing which teams are in office during which periods, with the goal of satisfying certain user-set optimization controls, such as ensuring maximum and consistent use of space as well as ensuring teams are in office the desired amount of time, while minimizing consecutive out-of-office periods for each team.

One optimization control considered during the first phase of optimization is a wiggle room control, which is a type of space constraint that needs to be satisfied by the optimization algorithm to produce an output. The wiggle room control allows the user to specify a certain amount of space in the office to be left vacant and not available for allocation by the optimization algorithm. For this optimization control, the associated space setting, if left blank, means this wiggle room control applies to the entire optimization as a whole. However, if the space setting has a value, the value specifies wiggle room for a particular part of the office space (e.g., “Bldg245|Floor12”). If the associated coefficient setting has a number over 1, this is interpreted as a number of seats to be vacant. If it is less than 1, it is interpreted as a portion/percentage of overall seats that should be left vacant (e.g., 0.05 indicates that at least 5% of overall seats should be vacant each period). Unlike the same setting for other optimization controls, the coefficient setting for this control is not relative to others but is an actual value.

Another optimization control considered during the first phase of optimization is a minimize vacancy control, which is a type of space preference that may or may not needs to be satisfied by the optimization algorithm to produce an output. The minimize vacancy control allows the user to express preference for minimization of vacant zones in the office. The associated coefficient setting indicates the strength of preference, where a larger value penalizes vacancy more, for example. An exemplary implementation of this preference can be: let c be the vacant coefficient and let v be the vector of vacant spaces per period. The objective component to minimize is then:

$$c {1}^{t} v .$$

Another optimization control considered during the first phase of optimization is a maximize fill control, which is a type of space preference that may or may not needs to be satisfied by the optimization algorithm to produce an output. Th maximize fill control allows the user to specify a consistent number of occupied spaces that need to be maintained over multiple periods of time, such as over all periods. The associated coefficient setting indicates the strength of preference. The associated space setting, if left blank, applies to the total number of occupied spaces. Otherwise, the space setting applies to the sum of earmarked seats of that type. One implementation of this preference can be: Let c be the coefficient and let v be the vector of filled spaces per period. Let c be the coefficient setting and

$$\overline{v} = {\sum }_{1}^{p} \frac{{v}_{i}}{p}$$

be the vector mean. The objective component to minimize is then:

$$c {\sum }_{i = 1}^{p} \vert {v}_{i} - \overline{v} \vert$$

Yet another optimization control considered during the first phase of optimization is a minimize-consecutive-out-of-office-periods control, which can be set by the user as either a preference or constraint. This optimization control allows the user to specify in-office requirements of the employee teams by providing a user-specified number of consecutive periods of time the employee teams are allowed to be out of the office. This optimization control can be associated with a period setting that can be set by the user to limit the number of consecutive out-of-office sequences, such as to two weeks or four weeks. The associated coefficient setting indicates the strength of preference, where the larger the value, the more it penalizes dispersion. If left blank, the coefficient setting is a constraint, in which case no out-of-office sequences of length 2 or 4 weeks is allowed. The associated org setting, if left blank, applies the optimization control to all teams equally. Otherwise, the optimization control only applies to the collection of teams specified by the org setting (e.g., as a collection of team tier names or team group names). An exemplary implementation of this optimization control is: for each team and each consecutive periods (e.g., 2 or 4), let x be the indicator that the team is out of office during those periods and c be the coefficient setting. The objective component to minimize is:

$$cx$$

Yet another optimization control for the first phase of optimization is a co-presence control, which can be set by the user as either a preference or constraint. This optimization control allows the user to specify a team be in office whenever another team or a collection of teams (e.g., a team tier or a team group) in the organizational hierarchy is in office at the same time. The associated org setting for this control allows the user to specify the team that wants another team (or collection of teams) to be in-office during the same time period(s). This optimization control can also be associated with an “other” setting that allows the user to specify the other team (or collection of teams). The associated coefficient setting specifies the strength of preference. If left blank, this optimization control is treated as a constraint. An exemplary mathematical implementation of this optimization control is: Let v be p-length vector of in-office periods for team specified by the org setting, and w for team in the “other” setting. If this optimization control is set as a constraint, it is implemented as:

$$w > = v .$$

If this optimization control is set as a preference, it is implemented as follows: Let c be the coefficient setting and x be the elementwise absolute value of w−v. The objective term is:

$$cx$$

For organization co-presence, for each period p let tₚ be the indicator that a team is in office during period p. Let c be the coefficient setting and t̅ₚ̅ be the mean over all teams, then for each period and team, add the following objective term:

$$c \vert {t}_{p} - \overline{{t}_{p}} \vert .$$

Yet another optimization control for the first phase of optimization is a period control, which can be set by the user as either a preference or constraint. This optimization control allows the user to specify a team or a collection of teams be in office during a specific period of time. The associated org setting for this control specifies the name of the team, tier or group. The associated period setting specifies the time period for in-office attendance. The associated coefficient setting specifies the strength of preference. If left blank, this optimization control is treated as a constraint. An exemplary mathematical implementation of this optimization control is: For each team, let c be the coefficient setting and v be an indicator that the team is in office during requested period. The objective term is:

$$- cv$$

In another aspect, one or more optimization controls are also provided for the second phase of optimization that determines team locations for each scheduled time period determined from the first phase of optimization. The goal of this second-phase optimization is to place teams at user-desired office locations during each scheduled time period (from the first phase of optimization), while satisfying certain user-set optimization controls.

One optimization control provided during the second phase of optimization is a dispersion penalty control, which is a preference that can or cannot be satisfied by the optimization algorithm to produce an output. This control allows a user to encourage a team or group members to be located near each other. This control can be applied to any level of the team structure, including the community, tribe or squad level. The associated org setting, if let blank, implies that this control applies to all teams. Otherwise, the dispersion penalty control only applies to the team name, team tier name, or team group name specified by the org setting. If a tier or team group name is given, the dispersion penalty control treats the specified tier/group as if it were a single large team. The associated coefficient setting provides the strength of preference for this control, where a larger value is adapted to penalize dispersion more. In some embodiments, while adjacency at a higher organization level is important, a higher coefficient value at a lower level can be leveraged to preserve specific team-based adjacencies. For example, given Organization A that is made up of Legal, Risk, and Compliance teams, the coefficient value for the dispersion penalty control for Organization A can be set by the user to 1,000, which encourages adjacent placement of all three teams within Organization A. If, within Organization A, a user wants to encourage adjacency amongst the Legal team, the user can set another dispersion penalty control for ‘Organization A’|‘Legal’ with a greater coefficient value than the initial entry of 1000 (e.g., a value of 2,000). Without the additional dispersion entry for the Legal team, the Legal team is adapted to spread across 2 floor—Flr 1 (100 seats): 25 Legal employees, 45 Compliance employees, 30 Risk employees; and Flr 2 (100 seats): 50 Legal employees, 10 Compliance employees, 40 Risk employees. In contrast, with the additional dispersion entry for the Legal team, the team is likely placed on a single floor in adjacent zones—Flr 1 (100 seats): 75 Legal employees, 25 Compliance employees; Flr 2 (100 seats): 30 Compliance employees, 70 Risk employees. Thus, assigning larger coefficient values to elements lower in the team structure/hierarchy promotes adjacency amongst specific teams versus larger organizations.

An exemplary mathematical implementation of this optimization control involves creating a collection of “clusters”, where a cluster is a set of zones that are at most a predefined distance apart. Let C be the indicator matrix of zones in clusters, d be the cluster distances, w be the vector of indicators of presence of org in clusters, and c be the dispersion coefficient, then the objective term can be:

$${cw}^{T} Cd .$$

Another optimization control available during the second phase of optimization is a shufflage penalty control, which can be set by the user as either a preference or a constraint. This control is specified by a user to discourage moving a team to different locations from one in-office period to the next. If the associated org setting is left blank, the control applies to all teams. Otherwise, the control only applies to the team name or a team group name specified by the org setting. In the latter case, the shufflage penalty control treats the specified group as if it were a single large team. The associated coefficient setting provides the strength of preference for this control, where a larger value is adapted to penalize shufflage more. If the coefficient setting is left blank, this control is treated as a constraint that needs to be satisfied, in which case the team or team group specified by the org setting is placed in the same location every scheduled time period. In the case that this control serves as a constraint and the org setting specifies a team group name, the complete co-presence of team is required. In some embodiments, similar to the coefficient setting for the dispersion penalty control described above, the coefficient setting for the shufflage penalty control can be set higher for specific teams versus larger organizations to discourage shufflage for lower levels in the company organizational structure. This control can also have a period setting that allows the user to set the name of period to apply the control to. Alternatively, if the period setting is left blank, it means that the control applies to all scheduled time periods. An exemplary mathematical implementation of this control is as follows: let c be the coefficient setting, let u be a vector setting the portion of the team's (or group's) headcount assigned to each zone for a time period in question, let v be the same vector for the previous time period, let x be the elementwise absolute value of u−v, let y be the greater of u−v and 0, and let d be for each zone, the minimum distance to a non-zero zone of u. The objective term becomes:

$$c {1}^{T} x + {cy}^{T} d .$$

Yet another optimization control available during the second phase of optimization is a co-location control, which is a preference that can or cannot be satisfied by the optimization algorithm to produce an output. This control allows a team to specify another team to be located nearby. The associated org setting provides the name of the team requesting the co-location. In some embodiments, this control is only usable for individual teams. For team tiers or groups, the dispersion penalty optimization control can be used to encourage proximity between team tiers or groups. An “other” setting associated with this control can be set to the name of the target team for co-location. The coefficient setting can be set to specify the strength of preference for this optimization control. An exemplary implementation of this control is as follows: let u be the barycenter for the current time period associated with the requesting team named in the org setting and let v be the barycenter for the current time period associated with the target team named in the “other” setting. Let c be the coefficient setting and x be the elementwise absolute value of u−v. The objective term can be:

$$cx .$$

Yet another optimization control available during the second phase of optimization is a location preference control, which can be set by the user as either a preference or a constraint. This optimization control allows a user to indicate the preference of a team to be in or near a specific location. The associated org setting specifies the name of the team, tier or group requesting the location preference. A “space” setting associated with this control specifies the name of the zone, zone tier or zone group requested. The associated coefficient setting specifies the strength of preference for this optimization control. If the coefficient setting is left blank, it means that the optimization control is a constraint that needs to be satisfied. An exemplary implementation of this control is as follows: let w be the portion of the team's (or group's) headcount assigned to the requested zone h. Let c be the coefficient setting and d be the vector of distances from h, i.e., Ph. If space is a collection of zones, then d is the vector of minimum distances of each zone h from any zone in the collection. If this optimization control is a preference, the objective term becomes:

$${cw}^{T} d .$$

Alternatively, if this optimization control is a constraint, the objective term becomes:

$${w}^{T} d = 0 .$$

Yet another optimization control available during the second phase of optimization is an exclusivity control, where can be set by the user as a constraint that needs to be satisfied during optimization. This optimization control allows a user to reserve a particular zone of the office for exclusive use by one or more employee teams. The associated org setting specifies the name of the team, tier or group requesting the exclusive use. A “space” setting associated with this control specifies the name of the zone, zone tier or zone group requested. An exemplary implementation of this control is as follows: let t be teams not specified by the org setting, and let h be zones in space, and A be the matrix of team-zone assignments, then:

$${A}_{i , j} = 0 ∀ i ∈ t ∀ j ∈ h .$$

In some embodiments, the two-phase optimization algorithm of step 210 of process 200 can be provided with one or more optional settings, including a Time Limit Schedule setting, a Time Limit Location setting, and a Time Best Location setting. The Time Limit Schedule setting allows the user to set the maximum time the first phase of optimization (i.e., the schedule optimization) can run. If an optimal solution is not found within this time period, the best result satisfying all constraints is then treated as optimal. The default for this setting can be 180 seconds. The Time Limit Location setting allows the user to set the maximum time the second phase of optimization (i.e., the location optimization) can run. If an optimal solution is not found within this time period, the best result satisfying all constraints is then treated as optimal. The default for this setting can be 180 seconds. The Time Best Location setting allows the user to stop execution of the optimization algorithm if a specific time length has lapsed since the last improvement in objective.

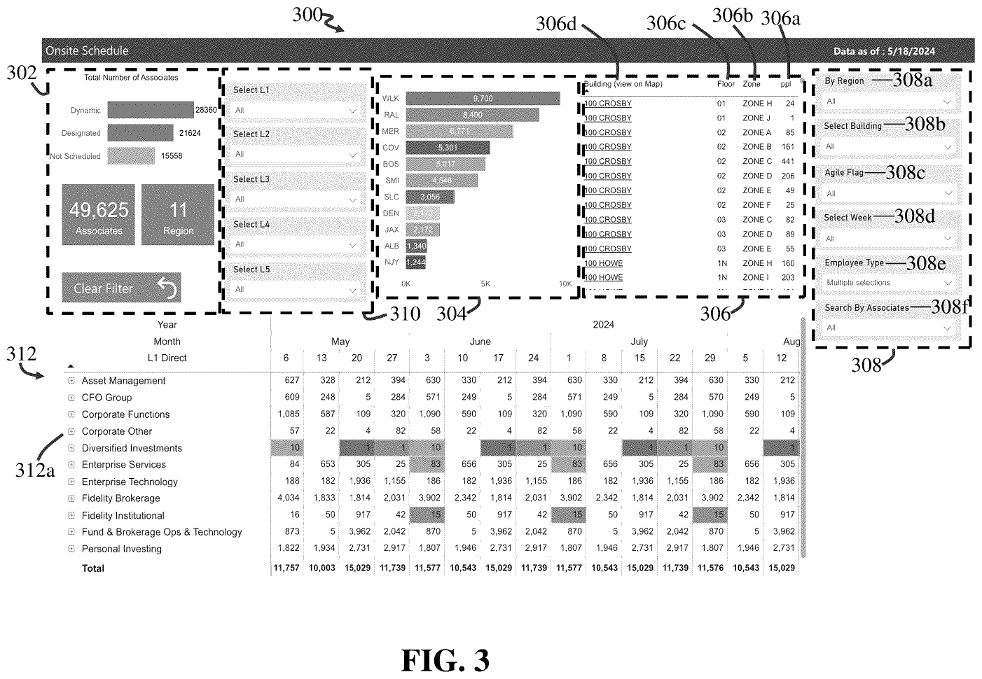

FIG. 3 shows an exemplary graphical user interface (GUI) 300 produced by the space and scheduling optimization system 100 of FIG. 1 to display optimization results to a user, according to some embodiments of the present invention. The GUI 300 is configured to display a summary of schedule and space assignments at the organization/enterprise level. This view can be drilled into by a user to understand specific assignments by a certain period (e.g., week), location or department. As shown, a zone 302 of GUI 300 is configured to display information related to the associates in the organization that are considered by the space and scheduling optimization system 100 for scheduling purposes. For this example, the associates in the organization are distributed across 11 geographical regions, where each region has at least one office building with one or more floors that are used to house these associates. As shown, “49,625” represents the count of associates in the organization that receive a schedule and space assignment developed by the optimization system 100 of FIG. 1 via the optimization process 200 of FIG. 2. For this example, schedule and space assignments are provided to these associates in 11 domestic regional sites. In some embodiments, each of the associates can be classified into one of two broad groups, dynamic or designated. Dynamic associates leverage “dynamic” space, which is fungible across all roles and teams. Designated associates have unique business requirements to align to specific, designated office footprints. This may due to unique technology needs (e.g., call center associated requiring desk phones) or associates requiring restricted spaces due to regulatory requirements (e.g., investment professionals), etc. Another zone 304 of the GUI 300 is configured to display in a graphical format, such as in a bar graph, the number of associates assigned by the space and scheduling optimization system 100 to each of the 11 different regions. For example, Boston (“Bos”) has 5,017 associates assigned to the building(s) in that region and Alabama (“ALB”) has 1,340 associates assigned to the building(s) in that region. Another zone 306 of the GUI 300 allows the user to further break down the assignments by buildings in those 11 regions. As shown, zone 306 of GUI 300 can display the number of associates (column 306a) assigned to each specific zone (column 306b) of each floor (column 306c) of each building (columns 306d) across those 11 regions.

In some embodiments, GUI 300 displays another zone 308 offering multiple filter options to the user to filter the optimization results, such as by region (filter 308a), select building (filter 308b), agile flag (filter 308c), select week (filter 308d), employee type (filter 308c) and/or associate names (filter 308f). The agile flag indicates if an associate is organized within an Agile structure. In some embodiments, GUI 300 displays yet another zone 310 of filter options that allows the user to filter the optimization results by various organization levels in the company hierarchy. For this example, the company has 5 levels (L1 to L5), with L1 being the highest and L5 being the lowest. Accounting for these filters, GUI 300 can display an optimization result table 312 showing associate assignments by hierarchy. More specifically, each row of table 312 shows associate assignment by department names at level 1 (L1) of the company hierarchy, where each level is expandable to show L2-L4 assignments under the same department. For this example, for each department (i.e., each row) in L1, table 312 displays the number of associates assigned in that department for each week of May, June and July in 2024. For instance, row 312a of table 312 shows that for the “Corporate functions” department, 1085 associates, 587 associates, 109 associates and 320 associates are assigned in the first, second, third and fourth weeks of May, respectively. From GUI 300, a user can drill down on any of the information displayed.

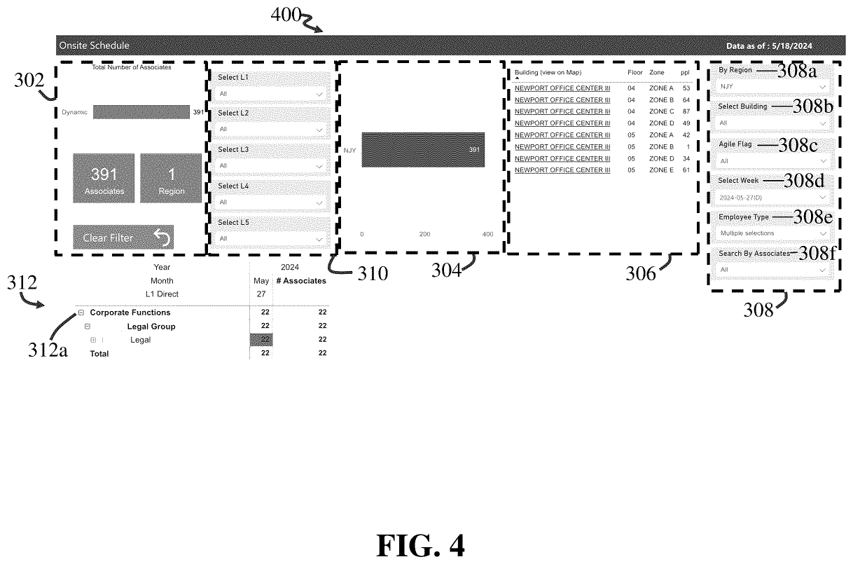

FIG. 4 shows another exemplary GUI 400 produced by the space and scheduling optimization system of FIG. 1 to present filtered associate assignment details after the user sets one or more filter options from GUI 300 of FIG. 3, according to some embodiments of the present invention. For this example, the user filters the assignment results of table 312 of FIG. 3 by a specific region (e.g., New Jersey (“NJY”)) at filter 308a and for the select week of May 27, 2024 at filter 308d. In response to the selection of these two filter options, zones 302, 304 and 306 and table 312 are updated to reflect associate assignments only relevant to these two filters-onsite associate assignments for the week of May 27^{th} in New Jersey. For instance, zone 306 only shows associate scheduling information related to the building (“Newport Office Center III) in New Jersey. In addition, the user can further filter the results in table 312 by a specific department. As shown, the user can choose to expand the “Corporate Functions” department, as specified in row 312a of table 312, to obtain a detailed view of associate assignment for the “legal” subdivision during the week of May 27^{th} in New Jersey.

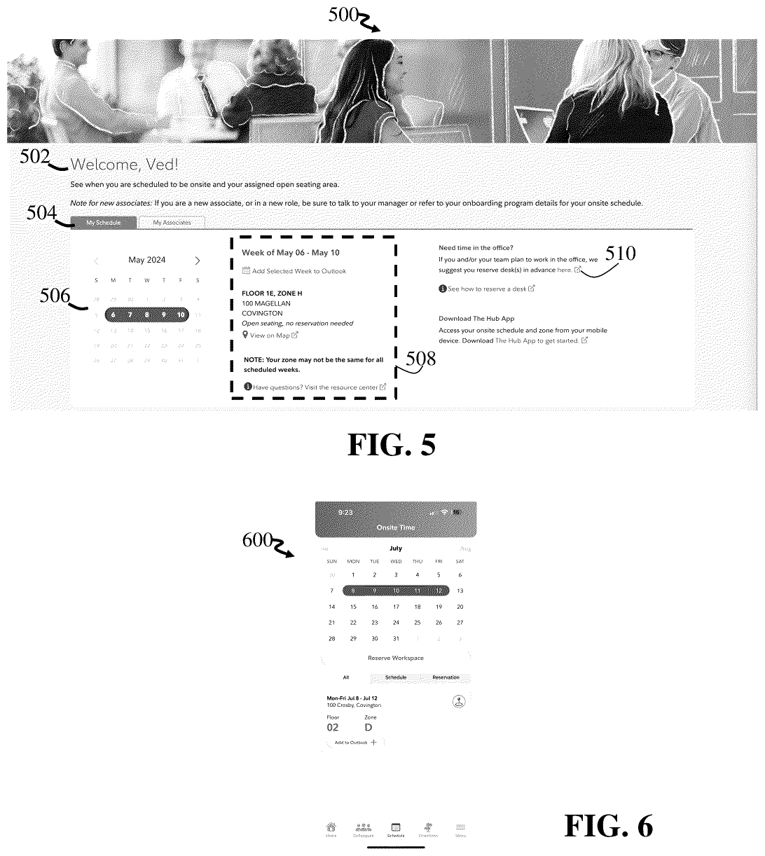

FIG. 5 shows yet another exemplary GUI 500 produced by the space and scheduling optimization system of FIG. 1 to present to an associate his/her schedule and space assignments and related details, according to some embodiments of the present invention. GUI 500 can identify the associate by name in the greeting region 502. Under the “My Schedule” tab 504 of GUI 500, the user can select a particular week from map region 506 to view his/her assignment information. After the desired week is selected, GUI 500 displays in region 508 the assignment information including the floor, zone and building of the assignment for that week. In some embodiments, additional details such as a link to a map visually illustrating the space assignment is included. Additionally, GUI 500 can include a link 510 for allowing the user to request onsite office space allocation at a desired location and for a desired time period. In some embodiments, GUI 500 is accessible through a mobile application offered to the employees of an enterprise. FIG. 6 shows an exemplary GUI 600 adapted for mobile devices, according to some embodiments of the present invention. GUI 600 can be configured to present substantially the same information as that on GUI 500 of FIG. 5.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

1. A computer-implemented method for scheduling a plurality of employees' attendance to an office and allocating office space to accommodate the plurality of employees, the method comprising:
receiving, by a computing device, enterprise information related to the plurality of employees including company organizational data defining a hierarchy of the employees;
assigning, by the computing device, each of the plurality of employees to a plurality of employee teams based on the enterprise information received, wherein each employee team is associated with a team size and a duration the employee team needs to be in the office;
receiving, by the computing device, office space data comprising a plurality of zones demarcating spaces within the office, wherein each zone is associated with one or more seats and a set of location coordinates;
adjusting by a user, via the computing device, a plurality of optimization controls comprising (i) one or more team group controls setting conditions on which of the employee teams should come into the office, (ii) one or more scheduling controls setting conditions on when the employee teams should come into the office, and (iii) one or more space controls setting conditions on which of the zones to allocate to the employee teams, wherein each of the optimization controls represents at least one of a constraint with conditions that must be satisfied or a preference with conditions satisfaction of which are optional; and
executing, by the computing device, an optimization algorithm to simultaneously schedule the employee teams attendance to the office over one or more periods of time while allocating the plurality of zones to the employee teams during the one or more periods of time, wherein the optimization algorithm receives as inputs the plurality of employee teams, the office space data and the plurality of optimization controls.

2. The computer-implemented method of claim 1, wherein each of the one or more seats in each zone is classified into one of a plurality of seat types including a common space, a restricted space, a dynamic space, a phone space, and a support space.

3. The computer-implemented method of claim 2, wherein the office space data further includes at least one of a space matrix providing a view of space capacity available for allocation via the optimization algorithm and space-designated data correlating the plurality of employee teams to their corresponding requirements on the seat types.

4. The computer-implemented method of claim 1, wherein the optimization algorithm is adapted to fail if an optimization control that represents a constraint cannot be satisfied, and wherein the optimization algorithm is adapted to generate at least one scheduling and allocation assignment if an optimization control that represents a preference is not satisfied.

5. The computer-implemented method of claim 1, wherein the optimization algorithm is a mixed-integer linear programming algorithm.

6. The computer-implemented method of claim 1, wherein each optimization control corresponds to a strength value indicating a degree of preference for the respective optimization control, and wherein a blank strength value indicates that the corresponding optimization control is a constraint the satisfaction of which is required.

7. The computer-implemented method of claim 6, wherein executing the optimization algorithm comprises executing a first phase for scheduling the teams attendance to the office over one or more periods.

8. The computer-implemented method of claim 7, wherein a wiggle room control of the first phase of optimization specifies a certain amount of space in the office to be left vacant and not available for allocation by the optimization algorithm.

9. The computer-implemented method of claim 7, wherein a minimize vacancy control of the first phase of optimization specifies minimization of vacant zones in the office, and wherein the corresponding strength value sets a degree of penalization against vacancy.

10. The computer-implemented method of claim 7, wherein a maximize fill control of the first phase of optimization specifies a consistent number of occupied spaces that need to be maintained over multiple periods of time, and wherein the corresponding strength value specifies an importance level of the maximize fill control.

11. The computer-implemented method of claim 7, wherein a minimize out-of-office control of first phase of optimization specifies in-office requirements of the employee teams by limiting a number of consecutive periods of time the employee teams are allowed to be out of the office, and wherein the corresponding strength value sets a degree of penalization against dispersion.

12. The computer-implemented method of claim 7, wherein a co-presence control of first phase of optimization specifies an employee team being in office at the same time as one or more other employee teams across the organizational hierarchy.

13. The computer-implemented method of claim 7, wherein a period control of the first phase of optimization specifies one or more employee teams that need to be to be in the office during a predefined period of time.

14. The computer-implemented method of claim 7, wherein executing the optimization algorithm further comprises executing a second phase at least once per scheduled period from the first phase for allocating the plurality of zones to the scheduled teams from the first phase.

15. The computer-implemented method of claim 14, wherein a dispersion penalty control of the second phase encourages a list of one or more user-specified employee teams to be located near each other, and wherein the corresponding strength value sets a degree of penalty for dispersion of the user-specified employee teams.

16. The computer-implemented method of claim 14, wherein a shufflage penalty control of the second phase discourages moving a list of one or more user-specified employee teams to a different zone during a user-specified time period in comparison to a previous time period, wherein the corresponding strength value sets a degree of penalty for shuffling the employee teams to the different zone.

17. The computer-implemented method of claim 14, wherein a co-location control of the second phase specifies a list of one or more employee teams to be located near each other.

18. The computer-implemented method of claim 14, wherein a location preference control specifies a zone of the office to place one or more user-specified employee teams.

19. The computer-implemented method of claim 14, wherein an exclusivity control reserves a user-specified zone of the office for exclusive use by a list of one or more user-specified employee teams.

20. A computer-implemented system for scheduling a plurality of employees' attendance to an office and allocating office space to accommodate the plurality of employees, the computer-implemented system comprising a computing device having a memory for storing instructions, wherein the instructions, when executed, configure the computer-implemented system to provide:
an input module configured to receive (i) enterprise information comprising company organizational data defining a hierarchy of the plurality of employees, and (ii) office space data comprising a plurality of zones demarcating spaces within the office each zone being associated with one or more seats and a set of location coordinates;
a team assignment module configured to assign each of the plurality of employees to a plurality of employee teams based on the enterprise information, wherein each employee team is associated with a team size and a duration the employee team needs to be in the office;
an optimization control adjustment module configured to allow a user to adjust a plurality of optimization controls comprising (i) one or more team group controls setting conditions on which of the employee teams should come into the office, (ii) one or more scheduling controls setting conditions on when the employee teams should come into the office, and (iii) one or more space controls setting conditions on which of the zones to allocated to the employee teams, wherein each of the optimization controls represents at least one of a constraint with conditions that must be satisfied or a preference with conditions satisfaction of which are optional; and
an optimization module configured to execute an optimization algorithm to simultaneously schedule the employee teams to come into the office over one or more periods of time while allocating the plurality of zones to the employee teams during the one or more periods of time, wherein the optimization algorithm receives as inputs the plurality of employee teams, the office space data and the plurality of optimization controls.

21. The computer-implemented system of claim 20, wherein the optimization algorithm is adapted to fail if an optimization control that represents a constraint cannot be satisfied, and wherein the optimization algorithm is adapted to generate at least one scheduling and allocation assignment if an optimization control that represents a preference is not satisfied.

22. The computer-implemented system of claim 20, wherein each optimization control corresponds to a strength value indicating a degree of preference for the respective optimization control, and wherein a blank strength value indicates that the corresponding optimization control is a constraint the satisfaction of which is required.
